(19) United States
(12) Patent Application Publication
(10) Pub. No.: US 2010/0196677 A1
(43) Pub. Date: Aug. 5, 2010

(54) HYBRID WOOD FLOORING

(76) Inventor: PETER BARRETTO, Gormley (CA)

Correspondence Address: BRYAN CAVE LLP, TWO NORTH CENTRAL AVENUE, SUITE 2200, PHOENIX, AZ, 85004, US

(21) Appl. No.: 12/696,718

(22) Filed: Jan. 29, 2010

Related U.S. Application Data
(60) Provisional application No. 61/202,113, filed on Jan. 29, 2009.

(51) Int. Cl. B32B 3/10; B32B 21/04; B32B 21/02

(52) U.S. Cl. 428/195.1; 428/537.1; 428/455

(57) ABSTRACT

In some embodiments, a hybrid wood material comprises a high density softwood core and a cork insulator joined together by an adhesive. The softwood core may comprise of Forest Stewardship Council softwood. Preferably, no formaldehyde is used in the fabrication of the material. The material may be used for flooring applications. Other embodiments are disclosed in this application.

### CROSS-REFERENCE TO RELATED APPLICATIONS

This application claims the benefit of U.S. Provisional Application No. 61/202,113, filed Jan. 29, 2009. U.S. Provisional Application No. 61/202,113 is incorporated herein by reference.

### FIELD OF THE INVENTION

The present invention relates to wood flooring, and in particular to hybrid wood flooring.

### BACKGROUND

Hardwood flooring has existed for many centuries in a site-finished, solid format. Prefinished engineered hardwood flooring was introduced in the 1950s. Engineering dramatically reduces the use of high-grade hardwood and makes hardwood flooring far less problematic and suitable for a wide range of end uses from residential to commercial applications. Prefinishing hardwood simplifies its installation such that installation can be done by either a professional or novice. Over the past two decades prefinished hardwood flooring has eclipsed unfinished hardwood flooring and gone from less than 5% of the floorcovering industry selling prefinished hardwood 20 years ago to approximately over 66% of the floorcovering industry currently selling prefinished hardwood. Prefinishing of hardwood flooring combined with the engineering technology has been the enabler of the past decade of compounded double-digit growth in the industry. Hardwood flooring now represents approximately 12-15% of the North American floorcovering industry.

However, many problems are associated with prefinished hardwood flooring. Prefinished hardwood flooring is relatively poorly resistant to fading or denting and it may also be poorly resistant to wearing, scratching, staining, cupping or warping, depending on the precise flooring product.

Prefinished hardwood floors are expensive and are also difficult and expensive to repair and expensive and slow to install at least partly due to the fact that exotic hardwood trees are required for manufacturing prefinished hardwood floors. Further, the price of hardwood floors is not stable.

Additionally, Prefinished hardwood floors have added formaldehyde. They also have color, stain, grade or gloss variation and are not resistant to dryness or humidity.

Laminate flooring was created and marketed in the early 1980s in Europe. Over the past two decades, the technology for this product has evolved considerably, creating a durable and multi-functional cost-competitive floor. The result has been the creation and growth of a multi-billion dollar business worldwide. Laminate flooring now represents approximately 8% to 10% of the North American floorcovering industry.

However, many problems are associated with laminate flooring. Consumer perception and visual aesthetics are typically considered low end and may be poor. Similarly, the natural feel and warmth of laminate floors is poor and may feel like plastic floors.

In order to produce custom colors of laminate floors, typically the floors must be produced in large volumes. Laminate floors can also be difficult to repair depending on the specific laminate floor product.

Laminate flooring also has added formaldehyde, which is undesirable.

The embodiments of the present invention addresses at least one of the above problems.

### SUMMARY

Disclosed is a hybrid wood material, comprising a high density softwood core layer having an upper surface and a lower surface; and an insulating layer attached to the lower surface using an adhesive.

### BRIEF DESCRIPTION OF THE DRAWINGS

In order that the subject matter may be readily understood, embodiments are illustrated by way of examples in the accompanying drawings, in which:

FIG. 1 is a plan view of a single tile of hybrid wood;

FIG. 2 is a plan view of two hybrid wood tiles covering a floor;

FIG. 3 is a cross-sectional view along line 3-3 of FIG. 1;

FIG. 4 is a plan view two hybrid wood tiles covering a floor using the uniclic joinery system; and

FIG. 5 is a cross-sectional view along line 5-5 of FIG. 4.

### DETAILED DESCRIPTION

Provided is a hybrid wood floor for interior commercial and residential floor applications. The hybrid wood floor uses a combination of Forest Stewardship Council (“FSC”) softwood fibers and post-industrial wood fibers compressed together with natural resin and high pressure to create a wood floor as hard as the hardest hardwood floors. No formaldehyde is added in the process of manufacturing the wood.

The disclosed hybrid wood floor can be manufactured or used in glue down planks or tiles, for example, or it can be manufactured or used along with a uniclic systems, joinery click system or other tongue and groove system as are known in the art.

Subject matter from the following patents may be used in connection with or in association with embodiments of the present invention:
(a) DE 10 2004 056 584
(b) DE 10 2004 018194 U1
(c) DE 10 2006 024 571
(d) EP 07008754.9
(e) DE 20 2004 018194
(f) DE 10 2006 024571 B3

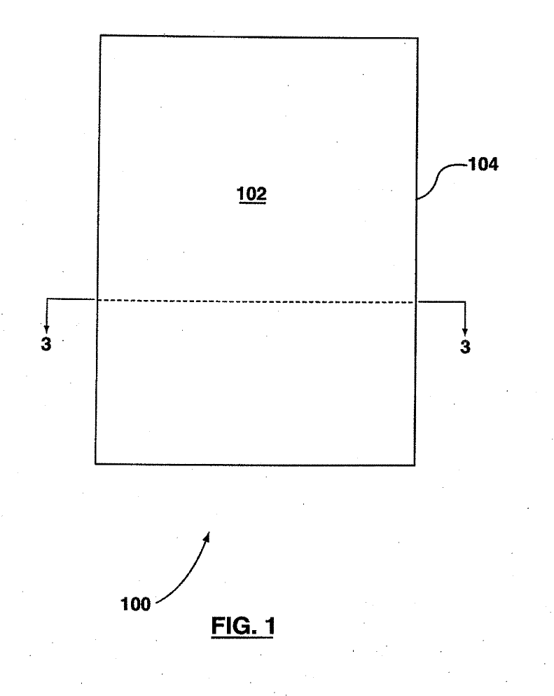

FIG. 1 shows a plan view of a floor tile made out of the hybrid wood material, shown generally at 100. The surface 102 of the floor tile 100 is preferably coated using an imaging and coating technology. For example, the technology described in European patent no. EP 1 862 304 A2 can be used to provide the surface 102 with the appearance of a hardwood floor. In order to enhance the appearance of hardwood flooring, the surface 102 can be imaged and coated such that repeating patterns do not appear, using methods known in the art.

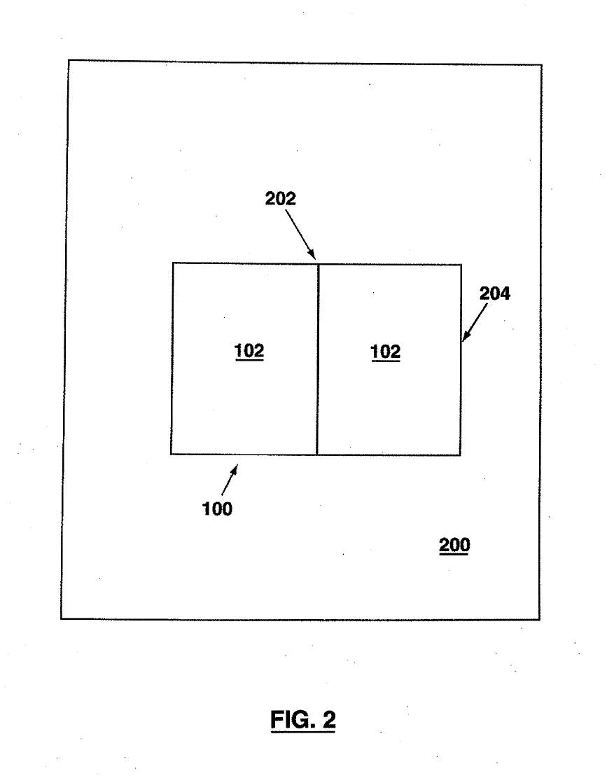

Tiles 100 may be glued down next to other tiles 100 to cover a surface such as a floor 200, as shown in FIG. 2. When used to cover a floor 200, the sides 104 of the tiles 100 may be next to and may be abutting other tiles (e.g. 202) or not (e.g. 204).

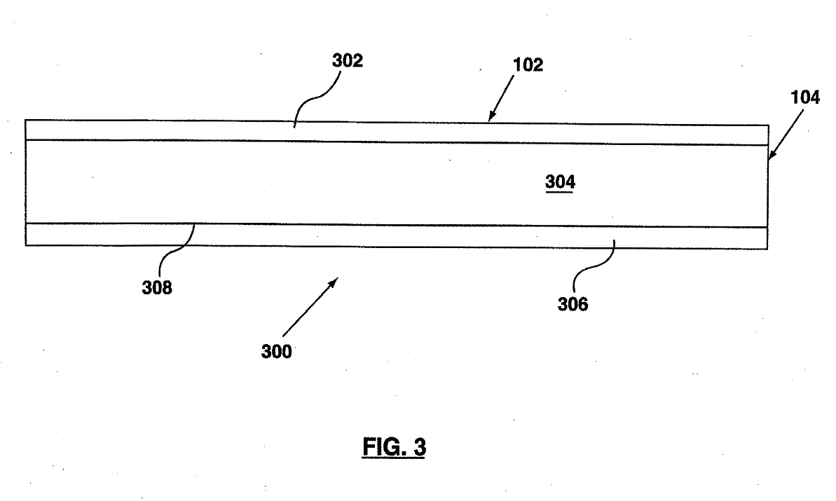

FIG. 3 shows a cross-section along line 3-3 of FIG. 1. The hybrid wood floor tile has three layers 302, 304, 306. The middle layer 304 is a high density softwood core, preferably FSC certified. The middle layer 304 may, alternatively, be fabricated from a combination of FSC softwood fibers and post-industrial wood fibers compressed together with a natural resin and high pressure. The bottom layer 306 is cork. The cork layer 306 can, for example, be post-industrial recycled cork. The cork 306 assists in providing natural heat and sound insulation, resulting in a quieter and warmer room when used in that room's floor. Sound transference to a room below is also reduced with the use of cork in the floors. The sound rating of cork is preferably Impact Insulation Class 58.

The middle layer 304 of high density softwood can be as hard as hardwood. The high density softwood preferably uses fast-growth FSC certified softwood fibers and also preferably does not contain any formaldehyde nor is any formaldehyde used in the its manufacturing process.

The surface layer 302 is coated and imaged with the appearance of a hardwood floor. As noted above, the technology described in European patent no. EP 1 862 304 A2 can be used to provide the surface layer 302 with the appearance of a hardwood floor. In order to further enhance the appearance of hardwood flooring, the surface layer 302 can be imaged and coated such that repeating patterns do not appear, using methods known in the art.

The surface layer 302 on the top surface of the middle layer 304. An adhesive 308 is used to bind the cork 306 to the bottom surface of the middle layer 304. The middle layer 304 is preferably free of formaldehyde.

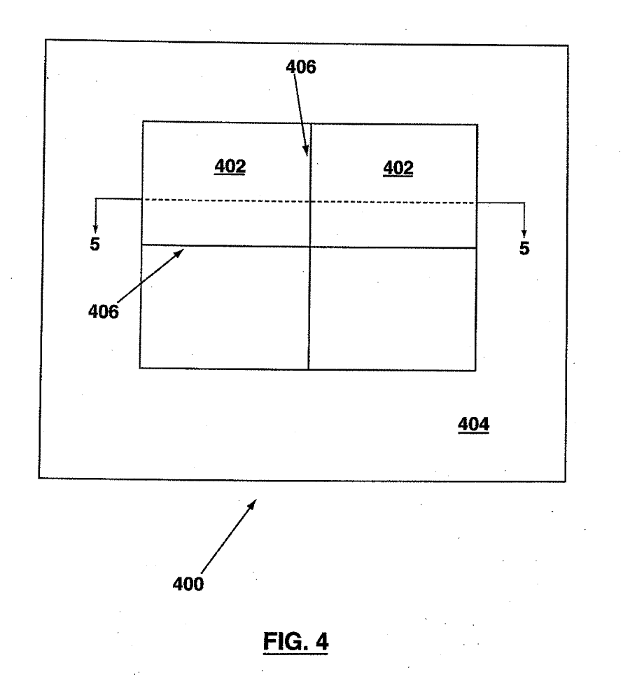

The hybrid floor may also be used and installed as a floating floor, with the uniclic system for joining hybrid floor tiles 402 together for example. FIG. 4 shows a plan view of four hybrid floor tiles 402 joined together using the uniclic system. The four hybrid floor tiles 402 partially cover a surface 404, as shown generally at 400. A uniclic system is used to join adjacent hybrid floor tiles together, shown at 406.

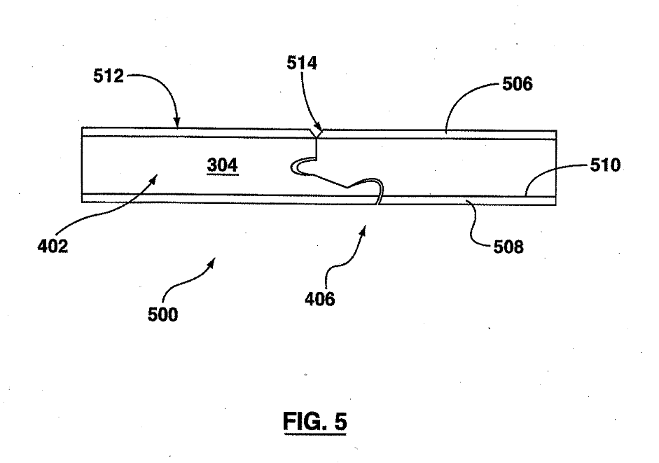

FIG. 5 shows a cross-section of two hybrid floor tiles 402 from FIG. 4 joined together using the uniclic system 406. The middle layer 304 is a high density softwood core, preferably FSC certified. The bottom layer 508 is cork. The cork layer 508 can, for example, be post-industrial recycled cork. As noted above, the technology described in European patent no. EP 1 862 304 A2 can be used to provide the surface layer 506 with the appearance of a hardwood floor. In order to enhance the appearance of hardwood flooring, the surface layer 506 can be imaged and coated such that repeating patterns do not appear, using methods known in the art. It is understood that the surface layer 506 may, for example, be the top surface of the middle layer 304.

The surface layer 506 is on the top surface of the middle layer 304. The middle layer 304 is preferably free of formaldehyde. An adhesive 510 is used to join the cork layer 508 to the bottom surface of the middle layer 304. Two adjacent tiles are joined together using a uniclic system 406 as described, for example, in Canadian patent no. 2 586 843.

Micro-beveled edges 514 may be formed at the upper edge of the hybrid floor tiles 402. When such tiles 402 are joined together using the uniclic system 406 (or other connector means), the micro-beveled edges 514 assist in preventing peaking, edge lipping or edge wear. Alternatively, square flush edges may be used (not shown).

The hybrid floor tiles 100 can be maintained in the same manner as hardwood floors are maintained. Further, the use of the described hybrid flooring provides protection from peaking, cupping, overall adhesion to the sub-floor, seaming or finishing, which is not available to prefinished hardwood floors or laminate floors.

The hybrid flooring system described is suitable for most internal residential and commercial floor applications. The hybrid flooring system can also be installed and used on, above or below grade.

What is claimed is:

1. A hybrid wood material, comprising:
a high density softwood core layer having an upper surface and a lower surface; and
an insulating layer attached to the lower surface using an adhesive.

2. The hybrid wood material of claim 1 wherein the insulating layer is cork.

3. The hybrid wood material of claim 2 wherein the cork is post-industrial cork.

4. Use of the material defined in claim 1 for covering floors.

5. Use of the material defined in claim 1 for covering walls.

6. Use of the material defined in claim 1 for covering ceilings.

7. The material of claim 1 wherein the material is cut into tiles for covering surfaces.

8. The material of claim 7 wherein the surfaces comprise floors.

9. The material of claim 7 wherein the surfaces comprise walls.

10. The material of claim 7 wherein the surfaces comprise ceilings.

11. The material of claim 1 wherein the upper surface of the high density softwood core is coated and imaged to appear like natural hardwood.

12. The material of claim 1 wherein the high density softwood core comprises Forest Stewardship Council softwood.

13. The material of claim 12 wherein the high density softwood core comprises manufactured from a combination of Forest Stewardship Council softwood fibers and post-industrial wood fibers compressed together with natural resin and high pressure.
